(19) United States
(12) Patent Application Publication
(10) Pub. No.: US 2021/0394327 A1
(43) Pub. Date: Dec. 23, 2021

(54) SYSTEMS AND METHODS FOR FORMING MULTI-SECTION DISPLAYS

(71) Applicant: CORNING INCORPORATED, CORNING, NY (US)

(72) Inventors: Gary Michael Huzinec, Horseheads, NY (US); Narvic Alan Shelanskey, Painted Post, NY (US); Heather Nicole Vanselous, Corning, NY (US)

(21) Appl. No.: 17/281,363

(22) PCT Filed: Oct. 1, 2019
(86) PCT No.: PCT/US2019/053938

§ 371 Date: Mar. 30, 2021

Related U.S. Application Data
(60) Provisional application No. 62/741,174, filed on Oct. 4, 2018.

(51) Int. Cl. B24B 9/10; B24D 3/06; B24D 3/28

(52) U.S. Cl. CPC B24B 9/10; B24D 3/28; B24D 3/06

(57) ABSTRACT

Embodiments are related to systems and methods for forming multi-tile display panels, and more particularly to systems and methods for forming display tiles having wrap-around edge electrodes.

### CROSS-REFERENCE TO RELATED APPLICATION

This application claims the benefit of priority under 35 U.S.C. § 119 of U.S. Provisional Application Ser. No. 62/741,174 filed on Oct. 4, 2018, the content of which is relied upon and incorporated herein by reference in its entirety.

### FIELD

Embodiments are related to systems and methods for forming multi-tile display panels, and more particularly to systems and methods for forming display tiles having wrap-around edge electrodes.

### BACKGROUND

Manufacturing of multi-tile displays often involves electrically connecting the display tiles and in some cases connecting electrical elements on one side of a display tile to electrical elements on the opposite side of the same display tile. Often such opposite side electrical connections are made using through-hole-vias, however, formation and use of such through-hole-vias can interfere with and/or damage electrical devices formed on a glass substrate. Use of wrap-around edge electrodes limits the need for problematic through-hole-vias. However, forming wrap-around edge electrodes to provide electrical interconnection is often difficult or unreliable where the display tile substrate is glass.

Hence, for at least the aforementioned reasons, there exists a need in the art for advanced systems and methods for manufacturing multi-tile displays.

### SUMMARY

Embodiments are related to systems and methods for forming multi-tile display panels, and more particularly to systems and methods for forming display tiles having wrap-around edge electrodes.

This summary provides only a general outline of some embodiments. The phrases “in one embodiment,” “according to one embodiment,” “in various embodiments”, “in one or more embodiments”, “in particular embodiments” and the like generally mean the particular feature, structure, or characteristic following the phrase is included in at least one embodiment, and may be included in more than one embodiment. Importa [symbol] phrases do not necessarily refer to the same embodiment. Many other embodiments will become more fully apparent from the following detailed description, the appended claims and the accompanying drawings.

### BRIEF DESCRIPTION OF THE FIGURES

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 is a flow diagram showing a method for manufacturing a multi-tile displays in accordance with some embodiments;

FIGS. 2a-2g show a subset of processing stages in accordance with one or more embodiments including chamfering one or more edges of a display tile having electronics formed near the chamfered edge(s) consistent with the method shown in FIG. 1;

FIGS. 3a-3f show an edge processing system and components thereof for chamfering a display tile having electronics formed near the chamfered edge in accordance with one or more embodiments;

FIGS. 4a-4b show a profile of a grinding wheel used for edge chamfering in accordance with various embodiments;

FIG. 5 is a flow diagram showing a method in accordance with some embodiments for separating a display tile from a larger panel; and

FIGS. 6a-6i depict various aspects of the singulation process discussed above in relation to FIG. 5.

### DETAILED DESCRIPTION

Embodiments are related to systems and methods for forming multi-tile display panels, and more particularly to systems and methods for forming display tiles having wrap-around edge electrodes.

In some cases, embodiments may be applied to yield edge geometries and surface quality on, for example, glass display tiles used in large screen, micro light emitting diode display (microLED display) arrays. The edge geometry and/or quality provided in some embodiments allow for formation of wrap-around electrodes used in connecting various electrical elements in the MicroLED display. As used herein, the phrase “electrical element” is used in its broadest sense to mean any device or structure capable of transferring and/or processing an electrical signal. Thus, an electrical element may be, but is not limited to, a conductor, a semiconductor, an electrode, a thin-film-transistor, a capacitor, a resistor, an inductor, a light emitting diode (hereinafter “LED”), an organic light emitting diode (hereinafter “OLED”), a liquid crystal cell, and/or an electrically controlled optical device. Based upon the disclosure provided herein, one of ordinary skill in the art will recognize a variety of electrical elements that can be used in relation to different embodiments.

In some cases, the aforementioned edge geometry and/or quality is established after electrical elements are formed on a display tile very near an unfinished edge (i.e., a non-rounded edge) of the display tile. In various cases, the electrical elements are within five hundred (500) micrometers (hereinafter “microns”) of the unfinished edge of the display tile. In various cases, the electrical elements are within two hundred fifty (250) microns of the unfinished edge of the display tile. In some cases, the electrical elements are within one hundred fifty (150) microns of the unfinished edge of the display tile. In some cases, the electrical elements are within one hundred (100) microns of the unfinished edge of the display tile. In various cases, the electrical elements are within seventy (70) microns of the unfinished edge of the display tile. The aforementioned electrical elements may be formed on only one side of the display tile, or may be formed on both sides of the display tile.

Various embodiments provide for display tile formation. Such methods include: forming a series of perforation craters along a cut line on a surface of a panel where the panel includes an electrical element formed on the surface of the panel, and where the cut line is within two hundred, fifty (250) microns of the electrical element. The methods further includes separating one portion of the panel from another portion of the panel alon [symbol] line to yield a display tile. In some instances of the aforementioned embodiments, the panel is a glass panel. In one or more instances of the aforementioned embodiments, the electrical element is a conductive trace.

In various instances of the aforementioned embodiments, the cut line is within one hundred (100) microns of the electrical element. In certain instances of the aforementioned embodiments, the cut line is a distance of less than or equal to sixty (60) microns of the electrical element. In some instances of the aforementioned embodiments, the cut line extends through the electrical element.

In some instances of the aforementioned embodiments, a maximum size of each of the perforation craters is less than forty (40) microns. In one or more instances of the aforementioned embodiments, a distance between two adjacent perforation craters is less than forty (40) microns. In certain instances of the aforementioned embodiments, the perforation craters are each formed by exposing the panel to laser energy. In various instances of the aforementioned embodiments, separating one portion of the panel from another portion of the panel along the cut line to yield the display tile includes mechanically breaking the panel along the cut line.

Some embodiments provide methods for display tile formation. Such methods include providing an edge processing system. The edge processing system includes: a display tile fixture, and a processing head. The display tile fixture is configured to hold a display tile in place during processing. An electrical element is formed on the display tile within two hundred, fifty (250) microns of an edge of the display tile. The processing head includes: a grinding wheel, a motor, and a movable arm. The grinding wheel includes a groove having a first width at an circumferential outer surface of the grinding wheel that is greater than a thickness of the edge of the display tile, and a second width within the groove that is less than the thickness of the edge of the display tile. As an example, in some cases where the display tile is made from Lotus NXT glass, the thickness of the edge of the display tile is 0.5 millimeters. The motor is coupled to the grinding wheel and configured to turn the grinding wheel. The methods further include: moving the movable arm such that the grinding wheel moves relative to the display tile fixture until the groove of the grinding wheel is over the edge of the display tile; and moving the movable arm such that the grinding wheel moves toward the edge of the display tile until opposing sides of the edge of the display tile contact the grinding wheel within the groove such that material from e [symbol] opposing sides of the edge of the display tile is removed. The edge of the display tile is modified without contact between the grinding wheel and the electrical element.

Other embodiments provide edge processing systems that include: a display tile fixture, and a processing head. The display tile fixture is configured to hold a display tile in place during processing. An electrical element is formed on the display tile within two hundred, fifty (250) microns of an edge of the display tile. The processing head includes: a grinding wheel, a motor, and a movable arm. The grinding wheel includes a groove having a first width at a circumferential outer surface of the grinding wheel that is greater than a thickness of the edge of the display tile, and a second width within the groove that is less than the thickness of the edge of the display tile. The motor is coupled to the grinding wheel and configured to turn the grinding wheel. The methods further include:

In some instances of the aforementioned embodiments, the electrical element is formed on the display tile within one hundred (100) microns of the edge of the display tile. In various instances of the aforementioned embodiments, the electrical element is formed on the display tile within seventy (70) microns of the edge of the display tile. In some instances of the aforementioned embodiments, a profile of the groove results in a modification of the edge of the display tile that replaces an abrupt transition with a rounded transition. As used herein, an “abrupt transition” is any transition between adjoining surfaces and/or edges of a display tile where formation of a wrap-around electrode has more than a one percent possibility of a discontinuity. As one of many examples, an abrupt transition may be a sharp corner between a surface of the display tile and an edge of the display tile. In some such instances, the rounded edge exhibits a curve distance of less than two hundred (200) microns. In various such instances, the rounded edge exhibits a curve distance of less than one hundred (100) microns. In some such instances, the rounded edge exhibits a curve distance of less than sixty (60) microns.

In some instances of the aforementioned embodiments, the grinding wheel is a resin bonded grinding wheel having between twelve (12) volume percent and twenty (20) volume percent diamond abrasives, and the diamond abrasives are between two (2) microns and thirty-five (35) microns. in various instances of the aforementioned embodiments, the grinding wheel is a resin bonded grinding wheel having between twelve (12) volume percent and twenty (20) volume percent diamond abrasives, and the diamond abrasives are between three (3) microns and sixteen (16) microns. In some instances of the aforemention [symbol] embodiments, the grinding wheel is a metal bonded grinding wheel having between twelve (12) volume percent and twenty (20) volume percent diamond abrasives, and wherein the diamond abrasives are between twelve (12) microns and thirty-two (32) microns. In some instances of the aforementioned embodiments, a depth of the groove is less than seventy (70) microns.

Yet other embodiments provide methods for making display tiles. The methods include: providing a display tile where the display tile has a glass substrate with at least one electrical element formed on the glass substrate within two hundred, fifty (250) microns of an edge of the display tile; mounting the display tile on a display tile fixture such that the edge of the glass substrate extends beyond an edge of the display tile fixture; providing a grinding wheel having a groove that exhibits a first width at a circumferential outer surface of the grinding wheel that is greater than a thickness of the edge of the display tile, and exhibits a second width below the circumferential outer surface of the grinding wheel where the second width is less than the thickness of the edge of the display tile; moving the grinding wheel relative to the display tile such that opposing sides of the edge of the display tile both extend into the groove and contact the grinding wheel below the circumferential outer surface of the grinding wheel; and further moving the grinding wheel toward the display tile such that material from each of the opposing sides of the edge of the display tile is removed. The edge of the display tile is modified without contact between the grinding wheel and the electrical element.

In some instances of the aforementioned embodiments, the grinding wheel has a distal end and a proximal end, and the groove is located a distance from the distal end; the display tile fixture has a height; and the distance is less than the height. In various cases, the edge of the glass substrate extends beyond an edge of the display tile fixture by a distance, and the distance is greater than a depth of the groove. In one case, the distance is between ten (10) microns and one thousand (1000) microns. In various cases, a profile of the groove results in a modification of the edge of the display tile that replaces an abrupt transition at the edge of the display profile with a rounded edge. In some cases, the at least one electrical element is a first electrical element formed on a first surface of the display tile, and the methods further include forming a wrap-around edge electrode extending from the first electrical element to a second electrical element formed on a second surface of the display tile, wherein the second surface is opposite the first surface.

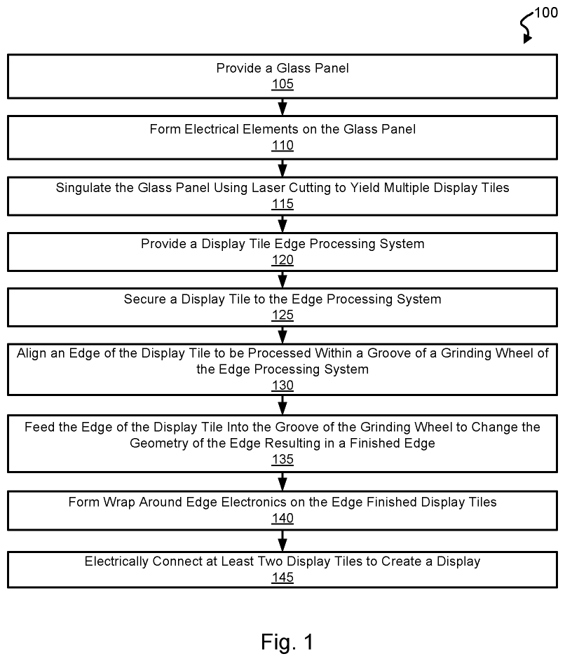

Turning to FIG. 1, a flow diagram 100 shows method for manufacturing [symbol] displays in accordance with some embodiments. The method of FIG. 1 includes forming edge profile geometries and finished edge surfaces adjacent to electrical elements formed on one or both of a first surface and a second surface of display tiles. Following flow diagram 100, a glass panel is provided (block 105). The glass panel may be formed of any type of glass suitable as a substrate upon which electrical elements can be formed. Based upon the disclosure provided herein, one of ordinary skill in the art will recognize a variety of glass materials and panel sizes that may be used in relation to different embodiments.

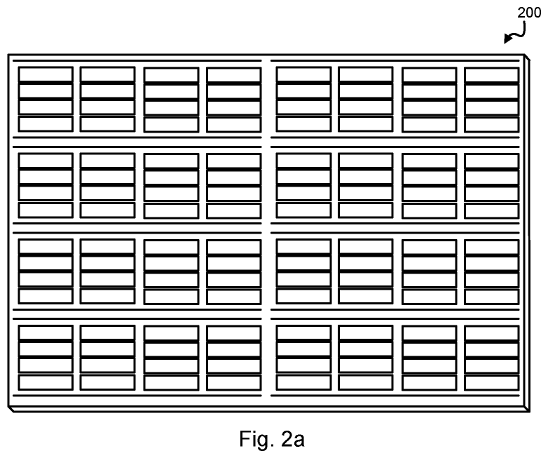

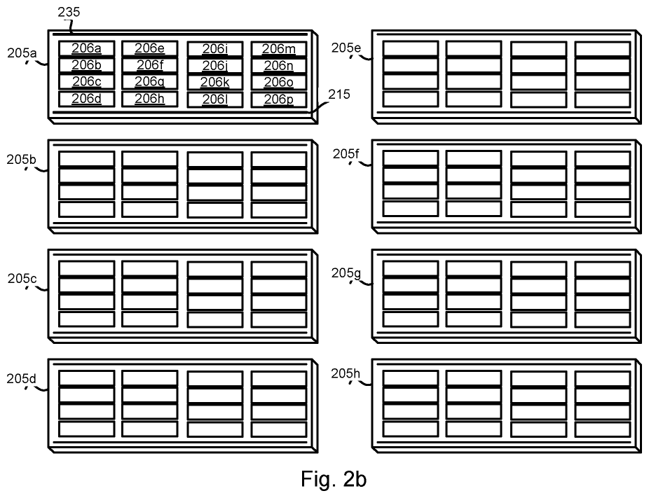

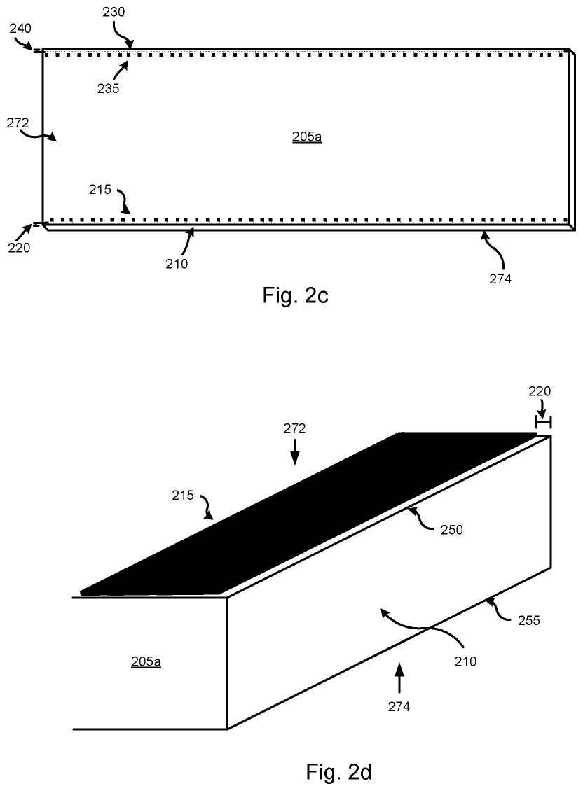

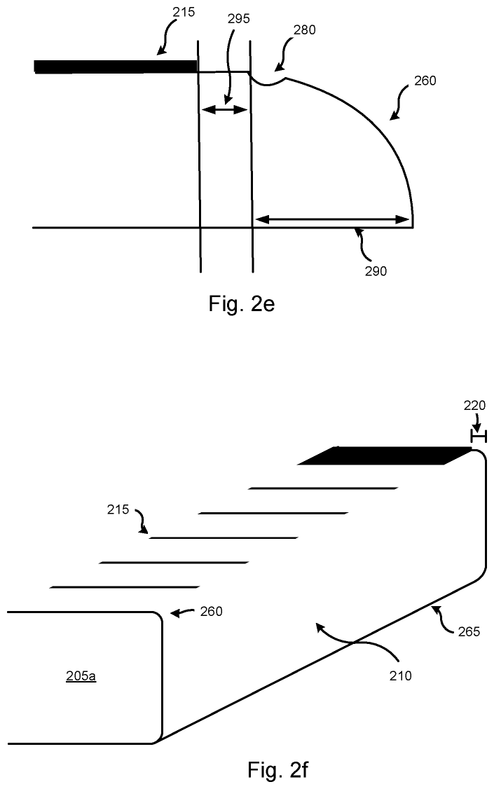

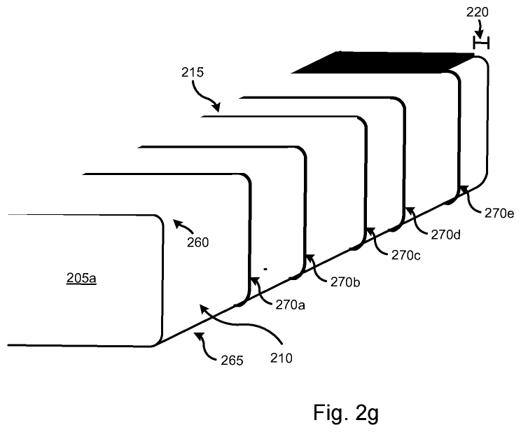

Electrical elements are formed on one or both surfaces of the glass panel (block 110). Where, for example, a display is to be manufactured, the electrical elements may include, but are not limited to, display elements such as LEDs, control circuits, and conductive traces. Based upon the disclosure provided herein, one of ordinary skill in the art will recognize a variety of electrical elements that may be formed on the glass panel in accordance with different embodiments. Further, any processes known in the art for forming electrical elements on a glass panel may be used. For example, formation of the electrical elements may include, but is not limited to, placing electrical elements on the display panel, fluidically depositing electrical elements on the display panel, forming thin film transistors directly on the display panel, or depositing or printing metal traces directly on the display panel. Based upon the disclosure provided herein, one of ordinary skill in the art will recognize a variety of processes that may be used to form electrical elements on the glass panel. Turning to FIG. 2a, an example glass panel 200 is shown that includes a variety of electrical elements in accordance with some embodiments.

In some instances of the aforementioned embodiments, the electrical element is formed on the display tile within one hundred (100) microns of the edge of the display tile. In various instances of the aforementioned embodiments, the electrical element is formed on the display tile within seventy (70) microns of the edge of the display tile. In some instances of the aforementioned embodiments, a profile of the groove results in a modification of the edge of the display tile (as the edge of the display tile is contacted by the grinding wheel) that replaces an abrupt transition at the edge of the display profile with a rounded edge. In some such instances, the resulting rounded edge exhibits a curve distance of less than two hundred (200) microns. In various such instances, the rounded edge exhibits a curve distance of less than one hundred (100) microns. In some such instances, the rounded edge exhibits a curve distance of less than sixty (60) microns.

In some instances of the aforementioned embodiments, the grinding whe [symbol] bonded grinding wheel having between twelve (12) volume percent and twenty (20) volume percent diamond abrasives, and the diamond abrasives are between two (2) microns and twenty (35) microns. In various instances of the aforementioned embodiments, the grinding wheel is a resin bonded grinding wheel having between twelve (12) volume percent and twenty (20) volume percent diamond abrasives, and the diamond abrasives are between three (3) microns and sixteen (16) microns. In some instances of the aforementioned embodiments, the grinding wheel is a metal bonded grinding wheel having between twelve (12) volume percent and twenty (20) volume percent diamond abrasives, and wherein the diamond abrasives are between twelve (12) microns and thirty-two (32) microns. In some instances of the aforementioned embodiments, a depth of the groove is less than seventy (70) microns.

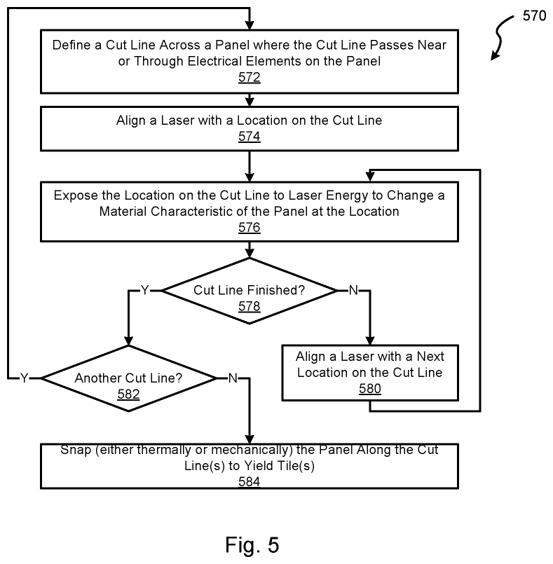

Returning to FIG. 1, the glass panel is singulated using a laser cutting tool to yield multiple display tiles (block 115). In some embodiments, the aforementioned singulating is done using a novel process discussed below in relation to FIGS. 5-8. Other methods for singulating may be used in relation to different embodiments including, but not limited to, scoring and snapping the lass panel to yield multiple display tiles. Turning to FIG. 2b, an example showing glass panel 200 singulated into a number of individual display tiles 205a, 205b, 205c, 205d, 205e, 205f, 205g, 205h is provided. Using display tile 205a as representative, each of the display tiles 205 includes a subset (electrical elements 206a, 206b, 206c, 206d, 206e, 206f, 206g, 206h, 206i, 206j, 206k, 206l, 206m, 206n, 206o, 206p, 215, 235) of the electrical elements included on display panel 200. As more clearly shown in FIG. 2c, some of the electrical elements (e.g., 215 and 235) are disposed near the edges of display tile 205a. In particular, electrical element 215 is shown a distance 220 from an edge 210 of display tile 205a, and electrical element 235 is shown a distance 240 from an edge 230 of display tile 205b. In some cases, electrical element 215 is within five hundred (500) microns of edge 210 of display tile 205a. In various cases, electrical element 215 is within two hundred fifty (250) microns of edge 210 of display tile 205a. In some cases, electrical element 215 is within one hundred fifty (150) microns of edge 210 of display tile 205a. In various cases, electrical element 215 is within one hundred (100) microns of edge 210 of display tile 205a. In some cases, electrical element 215 is within seventy (70) microns of edge 210 of display tile 205a. While FIG. 2c only shows electrical elements formed on a first surface 272 of display tile 205a, in some cases electrical elements may also be formed near the same edge on a second surface 274 (i.e, the surface opposite first surface 272).

Using edge 210 shown in FIG. 2d as representative, the laser singulation [symbol] abrupt transition at an unfinished edge 250 near a first surface 272 of display tile 205a, and another abrupt transition 255 near a second surface 274 of display tile 205a. Where a wrap-around electrode is to be formed extending from a region on first surface 272 to a region on second surface 274, such abrupt transitions at unfinished edges 250, 255 greatly increase the possibility of electrical discontinuity (open circuit) of a wrap-around electrode extending across the abrupt transitions.

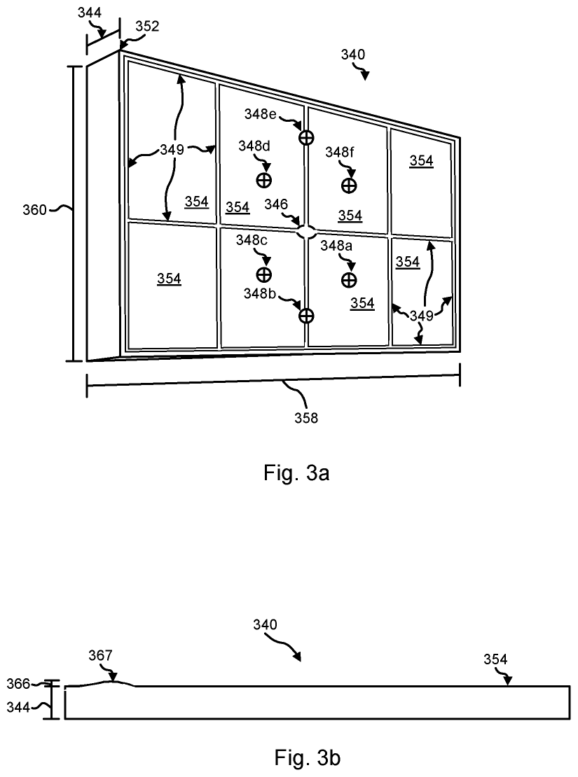

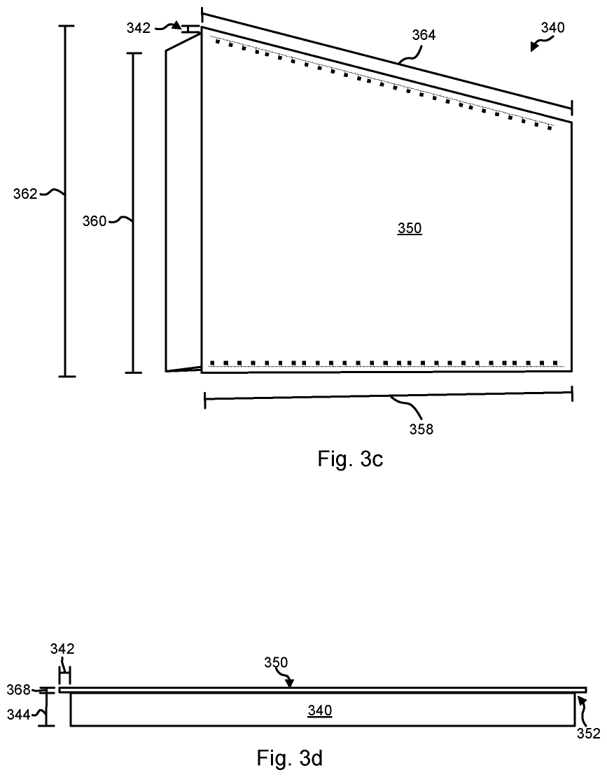

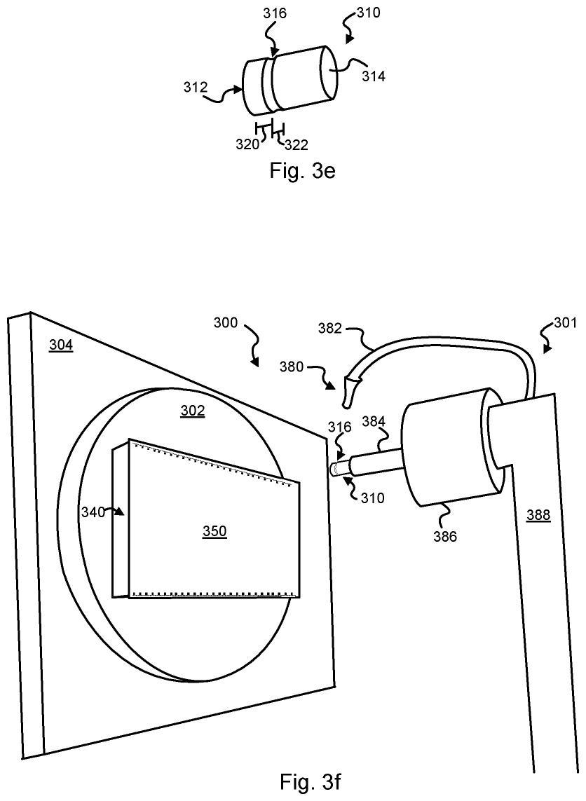

Returning to FIG. 1, a tile edge processing system is provided (block 120). The tile edge processing system includes a display tile fixture operable to hold a display tile in place during processing, and a grinding wheel with a groove having a geometry consistent with the desired edge geometry of the finished edge of the display tile. One embodiment of a tile edge processing system that may be provided is discussed below in relation to FIGS. 3a-3f. Based upon the disclosure provided herein, one of ordinary skill in the art will recognize other tile edge processing systems that may be used in relation to different embodiments.

In accordance with various methods described herein, a display tile is secured to the edge processing system (block 125). In some cases, the display tile fixture includes a vacuum port connected to vacuum channels on a working surface of the display tile fixture. In such cases, securing the display tile to the edge processing system includes placing the display tile on the display tile fixture and engaging the vacuum to secure the two together. Placement of the display tile relative to the display tile fixture is important as the edge of the display tile to be processed must extend beyond the edge of the display tile fixture a sufficient distance to allow the edge to move into a groove on the grinding wheel sufficiently to finish processing the edge of the display tile without an outer edge of the grinding wheel contacting the display tile fixture. Further, the distance that the display tile extends beyond the display tile fixture is limited to reduce the amount of flex exhibited at the edge of the display tile during grinding. Limiting the flex at the edge of the display tile increases precision of the grinding process allowing for close proximity of electrical elements to the edge being processed. In some embodiments, the distance of the edge of the display tile from the edge of the display tile fixture is only slightly greater than the final contact depth within the groove of the grinding wheel. In some cases, the distance from the edge of the display tile fixture to the edge of the display tile is greater than ten (10) microns and less than one thousand (1000) microns, and the final contact depth of the groove in the grinding wheel is less than twenty-five (25) microns. Based upon the disclosure provided herein, one of ordinary skill in the art will recognize a variety of final contact depths of the groove in the grinding wheel [symbol] distance of the edge of the display tile from the edge of the display tile fixture that that may be used in relation to different embodiments.

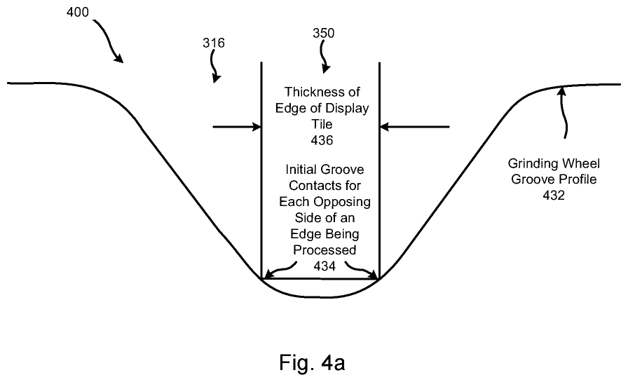

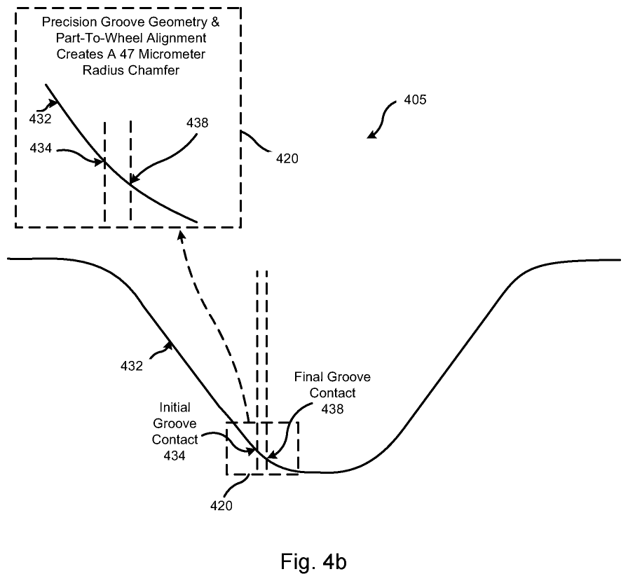

With the display tile secured to the display tile fixture, the grinding wheel is aligned with the edge of the display tile to be processed (block 130). To assure edge processing is uniform on both sides of the edge of the display tile, the display tile is substantially centered within the groove on the grinding wheel. FIG. 4a shows a profile view 400 of an example groove profile 432 of a groove in the grinding wheel with a substantially centered edge of the display tile extending into the groove to an initial contact point 434. In some cases, control of the aforementioned alignment is within fifteen (15) microns in any direction in a plane perpendicular to the large surfaces (e.g., surface 272 and surface 274 of display tile 205a) of the display tile.

An edge of the display tile is fed into the groove in the grinding wheel while maintaining alignment with the groove (block 135). In some embodiments, the feed rate of moving the groove of the grinding wheel along the edge of the display tile is five hundred millimeters per minute. In some cases a two step grind is performed to a defined depth using a rough grinding wheel with a feed rate of five hundred millimeters per minute along the edge of the display tile. The second grind step is performed using a fine grinding wheel using a feed rate of five hundred millimeters per minute across the edge of the display tile with the grind cutting is about seven (7) microns per pass (i.e., removing about seven (7) microns from the opposing sides of the edge of the display tile in a direction toward a center between the two edges on each pass). Based upon the disclosure provided herein, one of ordinary skill in the art will recognize other feed rates and cut depths that may be used in relation to different embodiments. The grinding process may continue to a depth into the groove that yields a fully rounded edge on the display tile, or continues only to a point that yields a desired chamfered edge with a straight face. Where the edge is fully rounded, the curve distance of the edge is in the range of one (1) to five hundred (500) microns. In some embodiments, the curve distance of the edge is in the range of one (1) to two hundred (200) microns. In various embodiments, the curve distance of the edge is in the range of one (1) to one hundred (100) microns. In some embodiments, the curve distance of the edge is in the range of one (1) to fifty (50) microns.

Turning to FIG. 2e, a profile view of part of edge 210 of display tile 205a [symbol] As shown, electronic element 215 extends within a distance 295 of the finished edge 260 of display tile 205a. A curve distance 290 of finished edge 260 is shown. As used herein, a “curve distance” is a linear distance measured along a line parallel to an upper surface of a display tile and extending from a beginning of a curve near the top surface of the display tile to an end of the curve on the edge of the display tile. In addition, an undesired conchoidal fracture 280 or chip is shown. Embodiments use grinding wheels and grinding kinematics (rotational velocity of the grinding wheel, feed rate of the groove over the edge of display tile, depth of final groove contact within the groove, and/or feed rate of the edge being processed into the groove) that reduce the size and likelihood of conchoidal fractures. In some embodiments, a planar distance from electronic element 215 to the unfinished edge (i.e., the edge prior to rounding) of display tile 205a is seventy (70) microns. Within this dimensional constraint, the process kinematics are selected to reduce the width of conchoidal fractures generated during the edge modification process at the edge-to-surface transition (e.g., from side 210 to surface 272 as shown in FIG. 2d) to less than ten (10) microns. This enables mechanical integrity of a later formed wrap-around electrode. The resultant edge chamfer plus conchoidal fracture width dimension is less than or equal to fifty (50) microns. This leaves a minimum clearance 295 of twenty (20) microns to the electrical elements around the entire periphery of the display panel. It should be noted that the aforementioned constraints and results are merely examples, and based upon the disclosure provided herein, one of ordinary skill in the art will recognize other constraints and results possible in accordance with other embodiments.

In some embodiments, two different grinding wheels 310 are used in series. A first grinding wheel 310 is a metal bonded abrasive grinding wheel used to perform a roughing process. In this roughing process, the rotational velocity of grinding wheel 310 is forty thousand (40,000) revolutions per minute, the surface feet per minute of the outer perimeter of grinding wheel 310 is between four thousand five hundred ninety-one (4591) and five thousand two hundred ten (5210), the feed rate of the edge being processed into groove 316 is five hundred millimeters per minute, and the depth of the cut (per pass) is fifty (50) microns.

Turning to FIG. 2f, finished edge 260 (and an opposite finished edge 265) is shown in relation to an overall side edge 210 of display tile 205a. As shown, edge 210 has been finished such that it is not fully rounded, but rather has a substantially flat face region extends between finished edge 260 and finished edge 265.

Returning to FIG. 1, wrap-around edge electronics are formed connecting elements on one side of the display tile to electrical elements on the opposite side of the display tile (block 140). The wrap-around edge electronics may be, for example, wrap-around electrodes that may be formed by, for example, spraying a conductive material from a top surface across the edge to the bottom surface using a spray nozzle. Based upon the disclosure provided herein, one of ordinary skill in the art will recognize a variety of methods and/or processes that may be used in relation to different embodiments for forming wrap-around electrodes. Turning to FIG. 2g, display tile 205a is shown with wrap-around electrodes 270 extending from electrical element 215 across finished edges 260, 265 to an electrical element (not shown) on the opposite side of display tile 205a. Returning to FIG. 1, two or more display tiles are electrically connected to yield a finished display (block 145).

Turning to FIG. 3a, a perspective view of a display tile fixture 340 is shown in accordance with some embodiments. As shown, display tile fixture 340 has a working surface 354 to which a display tile (not shown) can be mounted. Display tile fixture 340 has a height 344, a width 360, and a length 358. In some embodiments width 360 is between one hundred thirty (130) and one hundred forty (140) millimeters; length 358 is between two hundred forty (240) and two hundred fifty (250) millimeters; and height is less than fifty (50) millimeters.

A vacuum channel 349 is open at working surface 354 and extends into working surface 354. For example, vacuum channel 349 is open around a periphery of working surface 354 and across working surface 354. Vacuum channel 349 is connected to a vacuum source opening 346. A number of mounting screws 348 extend from below working surface 354 though display tile fixture 340, and operate to securely attach display tile fixture 340 to a mounting plate (not shown). A corner 352 of display tile fixture 340 is shown for orientation purposes.

In operation, a vacuum source (not shown) is attached to a vacuum source opening 346 via the non-working side of display tile fixture 340. The vacuum source is engaged causing a vacuum pressure to exist at vacuum source opening 346 near working surface 354. When a display panel tile (not shown) is placed on working surface 354 of display tile fixture 340, the display panel tile is held securely in place by the vacuum pressure from vacuum source opening 346 and extending through vacuum channel 349.

The precision of an edge modification made to a display tile mounted to [symbol] fixture 340 is limited by the flatness of working surface 354 on which the display tile rests. To assure a desired flatness, working surface 354 is diamond turned resulting in a reduction of the height of surface anomalies extending from a desired plane of working surface 354. Diamond turning is done by spinning display fixture 340 on a lathe relative to a diamond tipped tool that removes any surface anomalies protruding from working surface 354. An example of non-flatness is demonstrated in FIG. 3b showing cross-sectional view of display tile fixture 340 with surface roughness represented as a surface anomaly 367 extending above a desired plane by a distance 366. In some cases, distance 366 is less than one thousand (1000) nanometers. In various cases, distance 366 is less than five hundred (500) nanometers. In various cases, distance 366 is less than one hundred (100) nanometers. In some cases, distance 366 is less than one seventy-five (75) nanometers.

Turning to FIG. 3c, display tile fixture 340 is shown with a display tile 350 mounted thereon. Display tile 350 may be similar to, for example, display tile 205a discussed above. Display tile 350 has a width 362 and a length 364. Turning to FIG. 3d, a cross sectional view of display tile fixture 340 is shown with display tile 350 mounted thereon. As shown, display tile 350 has a height 368 (height of the substrate of display tile 350 and not including the higher of any electrical elements formed thereon) and extends a distance 342 beyond the edge of display tile fixture 340. Turning to FIG. 3e, a grinding wheel 310 is shown that may be used in relation to various embodiments. Grinding wheel 310 is a cylindrical element having a distal end 312 and a proximal end 314, and having one or more grooves 316 formed therein exhibiting a geometry corresponding to the desired geometry to be formed on the edge of display tile 350. A first of the one or more grooves 316 begins a distance 320 from distal end 312, and has a width 322 at the outer surface of grinding wheel 310.

In some embodiments, grinding wheel 310 is a resin bonded grinding wheel. A resin bonded grinding wheel provides more dampening than other types of grinding wheels, such as, for example, electroplated grinding wheels. Such dampening, among other things, reduces the size and volume of conchoidal fractures occurring during edge processing. In other embodiments, grinding wheel 310 is an electroplated grinding wheel. In some embodiments, a set of two grinding wheels is used. The first grinding wheel in the set is used for rough grinding. This first grinding wheel is a resin bonded grinding wheel including integrated diamond abrasives in the size of fifteen (15) to thirty (30) microns with a volume percent of diamond abrasive in the range of 12.5 to 18.75 volume percent. The second grinding wheel in the set is used for fine grinding. This second grinding wheel is [symbol] coated, resin bonded grinding wheel including integrated diamond abrasives in the size of four (4) to fifteen (15) microns, with a volume percent of diamond abrasive in the range of 12.5 to thirty (30) percent. In some cases, the volume percent of diamond abrasive is in the range of 12.5 to twenty-five (25) percent. In various cases, volume percent of diamond abrasive in the range of 12.5 to 18.75 percent. Based upon the disclosure provided herein, one of ordinary skill in the art will recognize other grinding wheels and implementations thereof that may be used in relation to different embodiments. For example, grinding wheel 310 may be, but is not limited to, single layer, electroplated wheels and abrasive belts (e.g., a single layer Trizact). Any abrasive component capable of being formed with precision and positioned accurately with respect to the tile may be used.

Where the side edges of display panel 350 are to be finished, width 364 is greater than width 358 by a sufficient amount to allow grinding wheel grove 316 to encompass the edge without contact between distal end 312 of grinding wheel 310 and display tile fixture 340. As such, distance 342 is greater than a final contact depth within groove 316. Further, distance 342 is limited to reduce the amount of flex exhibited at the edge of display tile 350 being processed. As such, distance 342 is only slightly greater than the final contact depth within groove 316. In some cases, distance 342 is less than one thousand (1000) microns and greater than ten (10) microns, and the final contact depth of groove 316 is less than fifteen (15) microns. Based upon the disclosure provided herein, one of ordinary skill in the art will recognize a variety of final contact depths of groove 316 and distances 342 that may be used in relation to different embodiments.

Additionally, to allow the edge of display tile 350 to slide inside groove 316 to an initial contact depth within groove 316 and then on to the final contact depth within groove 316, width 322 is larger than height 368. In some cases, width 322 is less than 1.5 millimeters and greater than 0.5 millimeters, and height 368 of display panel 350 is less than 1.3 millimeters and greater than 0.3 millimeters. Further, to allow grinding wheel 310 to pass freely along an edge of display tile 350, height 344 is greater than distance 320 when a block onto which display plate fixture 344 is mounted extends beyond the edges of display plate fixture 344.

Geometry of groove 316 of grinding wheel 310 is designed to accommodate a specific glass display tile thickness. Such geometry and display tile thickness determines the point of initial contact between sides of the display tile edge being processed and [symbol] In addition, such geometry and display tile thickness in addition to a depth into groove 316 that a display tile is fed determines the amount of material removed from the periphery of the display tile and the chamfer depth on the finished product. As such, the accuracy of the geometry of groove 316 and the alignment of groove 316 to the display tile is controlled. In some cases, control of the aforementioned alignment is within fifteen (15) microns in any direction in a plane perpendicular to the large surfaces of the display tile.

Turning to FIG. 3f, an edge processing system 300 is shown in accordance with some embodiments. As shown, edge processing system 300 includes display tile fixture 340 attached to a mounting plate 302. In turn, mounting plate 302 is attached to a fixed structure 304. As such, display tile 350 coupled to display tile fixture 340 becomes fixed in relation to fixed structure 304. In some cases, the mounting plate exhibits a surface area that is less than display tile fixture 340.

Edge processing system 300 further includes a processing head 301 that is movable relative to display tile 350 fixed on display tile fixture 340. Processing head 301 includes a motor 386 capable of rotating a securing element 384. Proximal end 314 of grinding wheel 310 is held securely in place by securing element 384 such that it rotates at the same speed as securing element 384. Processing head 301 further includes a cooling liquid tube 382 and a cooling liquid nozzle 380. During edge processing of display tile 350, a cooling liquid is passed through cooling liquid tube 382 and cooling liquid nozzle 380 and onto the interface of groove 316 in grinding wheel 310 to reduce any chipping and deformation of display tile 350. Processing head 301 is attached to a precision movement control (not shown) by an arm 388 allowing precise movement in three dimensions of groove 316 relative to the edge of display tile 350 being processed.

In operation, motor 386 is engaged such that grinding wheel 310 spins at a defined speed. Arm 388 is moved to slide groove 316 of grinding wheel over the edge of display tile 350 to be processed. Groove 316 is moved precisely relative to the processed edge such that both sides of the edge of display tile 350 contact a side of groove at an initial groove contact. FIG. 4a is a profile view 400 that shows an example groove profile 432 of groove 316. As shown, groove 316 is moved over display tile 350 having an edge thickness 436. As groove 316 is moved closer to the edge of display tile 350, opposite sides of the edge of display tile 350 that is being processed contact respective sides of groove 316 at initial groove contacts 434. By precisely centering groove 316 over the edge of display tile 350 that is to [symbol] processed, contact between opposing sides of the edge of display tile 350 and the inner wall of groove 316 occurs at substantially the same time leading for a uniform processing of opposing sides of the edge of display tile 350.

Processing continues by slowly pressing groove 316 further onto the edge of display tile 350 until it reaches a final groove contact 438 shown in FIG. 4b. The transition from initial groove contact 434 to final groove contact 438 is shown in a blow up area 420 of a profile view 405. As shown, each side of the edge of display tile 350 experiences a rounding consistent with groove profile 432 between initial groove contact 434 and final groove contact 438. In this particular case, an edge rounding with a curve distance of forty-seven (47) microns is achieved.

Selection of grinding process kinematics (rotational velocity of grinding wheel 310, feed rate of groove 316 over the edge of display tile 350, depth of final groove contact 438 into groove 316, feed rate of the edge being processed into groove 316, and/or rotational direction of grinding wheel 310 relative to the edge of display tile 350) and the composition of grinding wheel 310 (bond matrix material, secondary abrasive, primary diamond abrasive size, and fracture toughness) enables reduction in the size of the conchoidal fractures or chips at the edge-to-surface transition (e.g., from side 210 to surface 272 as shown in FIG. 2d). An example of such a conchoidal fracture was discussed above in relation to FIG. 2e. In a specific embodiment, a distance between the edge of display tile 350 and electrical elements formed on display tile 350 is seventy (70) microns. Within this dimensional constraint, the process kinematics are selected to reduce the width of conchoidal fractures generated during the edge modification process at the edge-to-surface transition to less than ten (10) microns. This enables mechanical integrity of a later formed wrap-around electrode. The resultant edge chamfer plus conchoidal fracture width dimension is less than or equal to fifty (50) microns. This leaves a minimum clearance of twenty (20) microns to the electrical elements around the entire periphery of the display panel. It should be noted that the aforementioned constraints and results are merely examples, and based upon the disclosure provided herein, one of ordinary skill in the art will recognize other constraints and results possible in accordance with other embodiments.

In some embodiments, two different grinding wheels 310 are used in series. A first grinding wheel 310 is a metal bonded abrasive grinding wheel used to perform a roughing process. In this roughing process, the rotational velocity of grinding wheel 310 is [symbol] thousand (40,000) revolutions per minute, the surface feet per minute of the outer perimeter of grinding wheel 310 is between four thousand five hundred ninety-one (4591) and five thousand two hundred ten (5210), the feed rate of the edge being processed into groove 316 is five hundred millimeters per minute, and the depth of the cut (per pass) is fifty (50) microns.

A second grinding wheel 310 is a resin bonded grinding wheel that is used to perform a finishing process. In this finishing process, the rotational velocity of grinding wheel 310 is forty thousand (40,000) revolutions per minute, the surface feet per minute of the outer perimeter of grinding wheel 310 is between four thousand five hundred ninety-one (4591) and five thousand two hundred ten (5210), the feed rate of the edge being processed into groove 316 is five hundred millimeters per minute, and the depth of the cut (per pass) is seven (7) microns. It should be noted that the aforementioned grinding process kinematics are used in one embodiment, and that based upon the disclosure provided herein, one of ordinary skill in the art will recognize other kinematics that may be used based upon the particular result desired.

Turning to FIG. 5, a flow diagram 570 shows a method in accordance with some embodiments for separating a display tile from a larger panel. Following flow diagram 570, a cut line is defined across a panel such that the cut line passes near or through electrical elements previously formed on the panel (block 572). The cut line defines the location where one or more display tiles will be separated from the panel and/or another display tile. Defining the cut line may include, for example, programming a number of locations corresponding to linear positions across a surface of the panel. In some cases, the cut line may be defined such that it cuts through electrical elements previously formed on the surface of the panel. In other cases, the cut line may be defined such that it cuts a selected distance away from electrical elements previously formed on the surface of the panel. In yet other cases, the cut line may be defined such that it cuts through some electrical elements previously formed on the surface of the panel, and cuts a selected distance from other electrical elements previously formed on the surface of the panel.

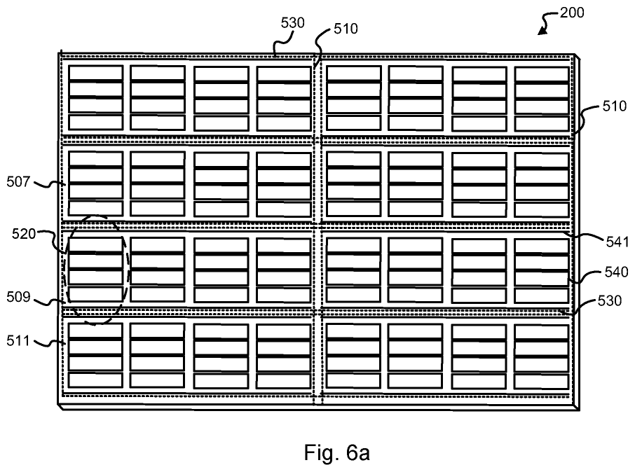

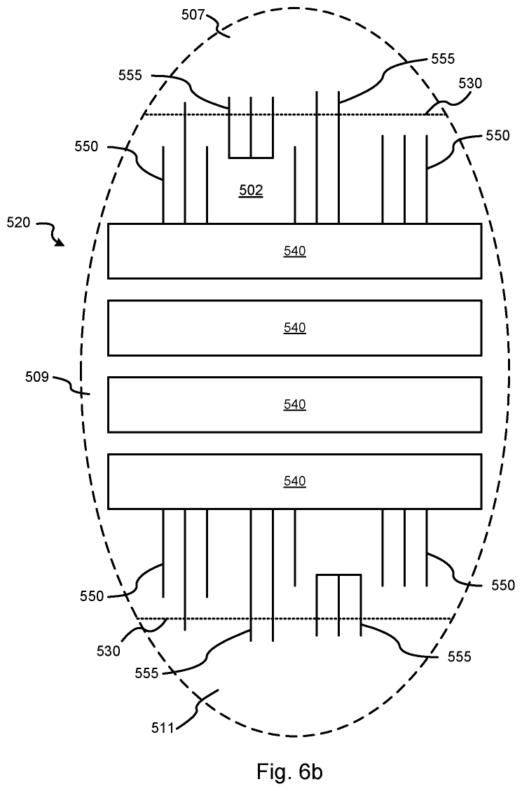

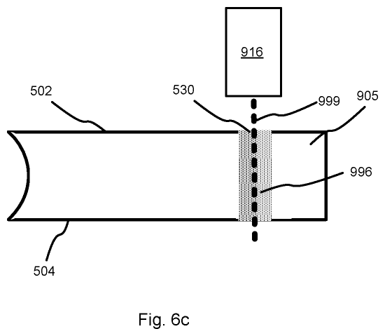

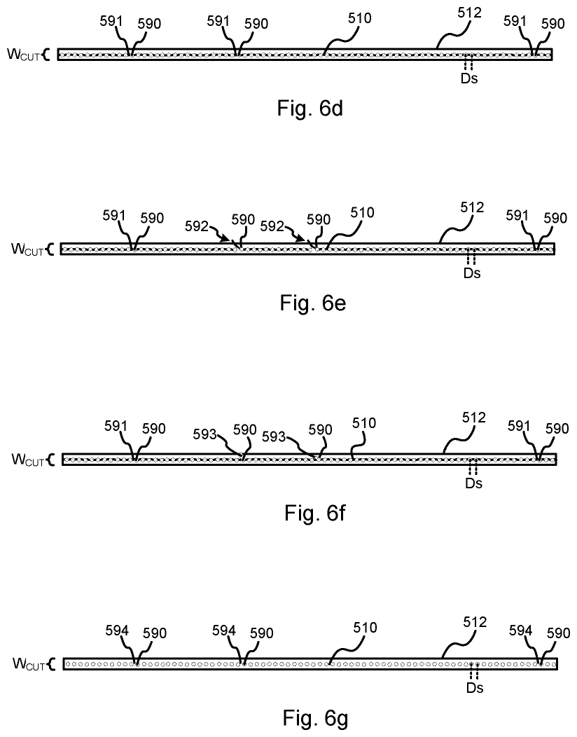

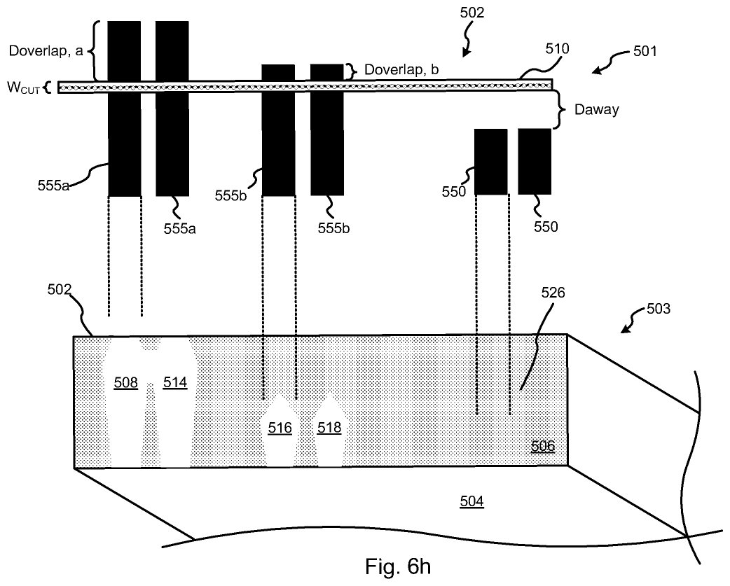

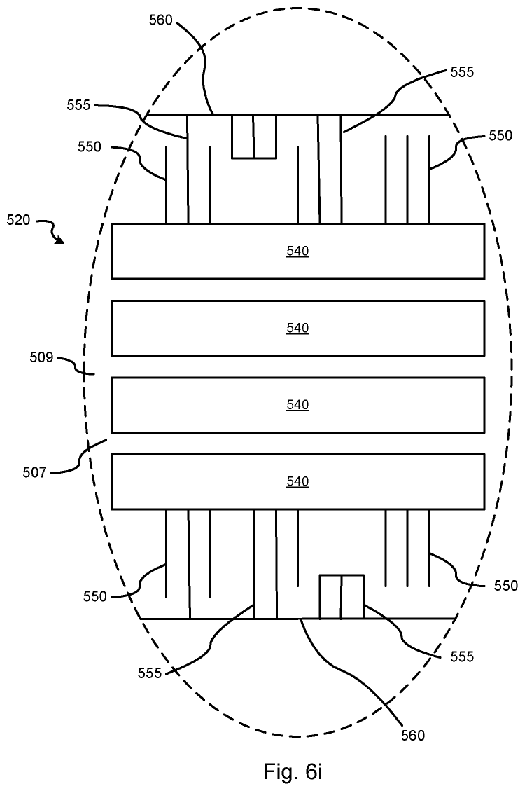

Turning to FIG. 6a, glass panel 200 as discussed above in relation to FIG. 2 is shown including a number of active or passive electrical elements 540 (e.g., resistors, capacitors, inductors, diodes, and/or integrated circuits), inactive electrical elements 541 (e.g., conductive traces), vertical cut lines 510 (shown as dashed lines), and horizontal cut lines 530 that correspond to boundaries of respective display tiles. Glass panel 200 is sepa [symbol] number of tiles (e.g., tile 507, tile 509, tile 511).

A region 520 is shown surrounded by an oval shaped dashed line. As shown in FIG. 6b, region 520 includes one or more active elements 540 on a first surface 502 and one or more inactive electrical elements 550, 555. Inactive electrical elements 550 include inactive electrical elements that extend from an interior area of a display tile toward a cut line (either a vertical cut line 510 or a horizontal cut line 530), but do not extend into or beyond the cut line. Inactive electrical elements 555 include inactive electrical elements that extend from an interior area of a display tile into or beyond a cut line (either a vertical cut line 510 or a horizontal cut line 530) so that when a cut is formed along the cut line, a portion of the inactive electrical element 555 extending into or beyond the cut line will be destroyed. In some cases, region 520 includes one or both of active and/or inactive elements on a second surface (not shown) that is opposite first surface 502.

Returning to FIG. 5, a laser and the panel translated relative to one another such that the laser is in position to begin moving across the cut line (block 574). This may include, but is not limited to, aligning the laser with a selected cut line along a selected edge of the panel. Such an alignment facilitates making a cut beginning at one edge of the panel and continuing to the opposite edge of the panel. Turning to FIG. 6c, a side view is depicted of a laser 916 aligned with a cut line (not shown) along first surface 502 of a substrate 905. A beam 999 of laser energy is pulsed as laser 916 moves relative to substrate 905 along the cut line. Where it is not blocked, beam 999 passes through substrate 905 to an opposite, second surface 504. As the laser energy passes through substrate 905 a material characteristic of substrate 905 is changed in a region 996 surrounding beam 999. Where an opaque material, such as, for example, a conductive trace interferes with the passage of beam 999 through substrate 905, portions of region 996 may not be changed. This change of a material characteristic of substrate 905 and/or a failure to change the material characteristic of substrate 905 is discussed in more detail below in relation to FIG. 6h. Based upon the disclosure provided herein, one of ordinary skill in the art will recognize a variety of laser alignments that may be used in relation to different embodiments. Details of a Bessel beam laser that may be used in relation to different embodiments are set forth in US Pat. Pub. No. 20140199519 entitled “Method and Device for the Laser-Based Machining of Sheet-Like Substrates”, and filed Jan. 14, 2014 by Schillinger et al. The entirety of the aforementioned reference is incorporated herein by reference for all purposes.

The location of the cut line to which the laser is aligned is exposed to las [symbol] such that a material characteristic of the panel is changed around the location (block 576). In some embodiments, the change in the material characteristic is a change in a refractive index of the panel at the location which results in a weakening of the material at that location. In various embodiments, to create a uniform edge along the cut line the focal line of the laser energy is longer than the thickness of the panel being cut, such that a uniform crack was generated throughout the panel. As an alternative embodiment, the electrical elements on the panel may be formed such that they extend beyond the cut line and thereby will be directly exposed to the laser energy. In such embodiments, the electrical element is partially ablated during the exposure to the laser energy, and absorbs a significant portion of the laser energy. This absorption may result in a non-uniformity along the edge that can be corrected using a mechanical or chemical edge polishing step before forming side electrodes over the edge. Examples of such non-uniformity are discussed below in relation to FIG. 6h.

It is determined whether the cut line has been finished (block 578). Where the cut line has not been finished, the laser is aligned with a next location along the defined cut line (block 580) and the exposure process (block 576) is repeated for the next location. This process continues making a series of exposures along the cut line until the cut line has been completed (block 578). The series of exposures result in a perforation like changes in the material characteristic of the panel along the cut line.

Turning to FIGS. 6d-6g, top views (looking toward first surface 502) of various perforation like changes in the material characteristic of the panel along the cut line are shown that may be achieved depending upon particular setting used during the laser perforation. Turning to FIG. 6d, a cut line is show having a width (Wcut). Wcut represents a distance extending from both sides of a cut line 510 where damage to electrical elements disposed on the surface of channel may be expected. A damage line 512 indicates an area measured from a cut line 510 where damage is expected. In some embodiments, Wcut is thirty (30) microns centered on cut line 510, thus damage line 512 is approximately fifteen (15) microns from cut line 510. As shown, cut line 510 includes a series of laser exposure perforation craters 590 separated by stress cracks 591 and a distance (Ds). In some embodiments, the size (i.e., a maximum distance from one side to an opposite side) of craters 590 varies from 0.5 microns to forty (40) microns. In certain embodiments, the size (i.e., a maximum distance from one side to an opposite side) of craters 590 varies from one (1) micrometer to twenty (20) microns. In various embodiments, Ds varies from 0.05 microns to forty (40) microns. In certain embodiments, Ds varies from 0.2 microns to twenty microns. In some embodiments, the laser can be operated with a pulse duration in the range of 0.1 picoseconds to about one hundred (100) picoseconds, and the repetition rate can be in a range from about one (1) kilohertz to about four (4) megahertz. In addition to this single pulse operation, the pulses can be produced in bursts of two or more pulses separated by a duration between individual pulses within a burst of about one (1) nanosecond to about fifty (50) nanoseconds at a burst repetition frequency between one (1) kilohertz to about four (4) megahertz. The pulse burst laser beam can have a wavelength selected such that the substrate material is substantially transparent at the selected wavelength, such as one thousand sixty-four (1064) nanometers, five hundred thirty-two (532) nanometers, three hundred fifty-five (355) nanometers, and two hundred sixty-six (266) nanometers. The laser can exhibit an energy per burst in the range of about twenty-five (25) microjoules to about seven hundred fifty (750) microjoules. In certain embodiments, craters 590 are formed using bursts five bursts of three hundred fifty (350) microjoules of laser energy at a six (6) micrometer pitch and a rate of one hundred thousand (100K) Hertz.

Stress cracks 591 occur due to application of laser energy to laser exposure craters 590. Ideally, as shown in FIG. 6d, stress cracks 591 extend between craters 590. However, as shown in FIG. 6e, improper application of the laser energy to cause laser exposure perforation crater 590 can result in undesirable stress cracks 592 that extend away from cut line 510 and in some cases even beyond damage line 512. Such stress cracks 592 can be caused, for example, due to the application of too much overall laser energy and can be present on the laser entrance (i.e., first surface 502) and/or exit side (i.e., second surface 504). In other cases, such stress cracks 592 can be caused due to laser energy focused below the panel (e.g., in some cases caused when the focal line is set to be longer than the thickness of the panel, so that the process is less sensitive to any positional offsets) being reflected back by a carrier holding the panel. In some embodiments, the panel is processed on, for example, a paper surface that has been found to eliminate the defect on second surface 504. If observed on first surface 502, the energy of the laser can be lowered. Stress cracks 592 were found to occur when the laser energy was increased about one hundred fifty (150) percent from three hundred fifty (350) microjoules with all other aspects of the processing maintained constant. Alternatively, stress cracks 592 may result by allowing the panel to cool too much between successive exposures to the laser energy. Thus, to avoid undesirable stress cracks 592 and corresponding chips, the period of time between application of energy at a one laser exposure perforation crater 590 and the next laser exposure perforation crater 590 is control [symbol] the period of time is too long, heat from the laser exposure at a prior laser exposure perforation crater 590 dissipates and thus increases the possibility that an undesired stress crack 592 forms. Regardless of the causal mechanism, stress cracks 592 may result in chips being formed along the edge of the tile near either or both of the top and bottom surfaces upon separation from the panel along the cut line.

Other problems can occur where too much laser energy (either in magnitude or exposure time) is applied in a unit area to one or more of craters 590. FIG. 6f shows an example of this phenomena at locations 593 where a portion of the panel material is ablated due to excess energy. The ablation is relatively shallow as only a portion of material at the surface of the substrate is ablated, but this relatively shallow ablated area leaves a point of damage at the transition from a top surface to the side of the resulting tile. When separated along the cut line the aforementioned surface damage appears to be chips at the transition from a top surface to the side of the resulting tile. Such chips may render formation of a side electrode less successful. Further, in some cases the ablation may extend beyond damage line 512. In some cases, reducing the pitch about thirty-five percent from six (6) microns caused a defect similar to that shown in FIG. 6f. Increasing the energy of the laser may result in similar ablation near crater locations.

Yet other problems can occur where the energy from the laser is too low (either in magnitude or exposure time) as it fails to generate sufficient energy to cause stress cracks 591. An example of this is shown in FIG. 6g where cut line 510 includes only laser exposure perforation craters 590 without stress cracks at locations 594 extending between such craters 590. The lack of stress cracks 591 may result in chips being formed along the edge of the tile near either or both of the top and bottom surfaces when a tile is separated from the panel along the cut line. Such lack of stress cracks can be caused by lowering the laser energy about forty-five (45) percent from three hundred fifty (350) microjoules to two hundred (200) microjoules.

The effects of laser energy directed at the series of laser exposure perforation craters 590 along cut line 510 varies depending upon whether the surface of the panel impacted by the laser energy includes electrical elements either disposed over or near the laser exposure craters 590. In particular, the numerical aperture and length of a Bessel beam (i.e., a Gaussian beam is directed through an axicon where the axicon is focused at a further distance in the direction of propagation, such that a focal line, rather than a point, is formed varied such that the cut lines can be close to electrical elements on the surface of the panel without damaging such electrical elements or affecting the edge uniformity after separation. Any objects on the surface of the panel (e.g., electrical elements) which absorb, reflect, scatter, or otherwise perturb the wavelength of light at which the laser is operating or the coherence of the beam can pose a challenge to the process of changing the material characteristic of the panel by exposure to the laser energy. In some embodiments, to cut near conductive traces on the surface of the panel, a one thousand sixty-four (1064) nanometer Bessel beam is generated that exhibits an approximately 1.7 millimeter full-width at half-maximum (FWHM) line length with a numerical aperture (NA) of 0.27. Such a geometry has been found effective for cutting as close as sixty (60) microns away from a conductive trace on the surface of the panel while maintaining a uniform edge. Decreasing the NA further (i.e., decreasing the cone angle of the Bessel beam), would allow the cut line to be even closer to the electrical elements without shadowing effects. In some cases, cuts within thirty (30) microns of a conductive trace on the surface of the panel are possible without shadowing effects where additional controls such as, for example, decreasing the NA in accordance with some embodiments. Such a modification, however, would increase the diameter of the cone of light which forms the focal line. In some cases, this causes a wider ablation zone at the surface (i.e., increases the size of craters 590). Therefore, there needs to be a balance between cutting proximity to tile edges, damage to electrical components on the surface of the panel, and/or cutting effectiveness.

As cutting gets closer to electrical elements or even cuts through electrical elements, shadowing effects start to become more prominent. Turning to FIG. 6h, a top view 501 and a perspective side view 503 of a panel and corresponding cut line 510 are shown. As shown, the panel includes first surface 502 to which the laser energy is directed and opposite, second surface 504. A side 506 of the panel is shown after the panel is snapped along cut line 510 and shows various anomalies occurring at the cut edge 506.

As shown, two different types of electrical elements 550, 555 are shown near cut line 510. In particular, electrical elements 555 are conductive traces on surface 502 of the panel that extend into or beyond cut line 510, and electrical elements 550 are conductive traces on surface 502 of the panel are near but do not extend into or beyond cut line 510. More particularly, electrical elements 555a extend a distance (Doverlap,a) beyond cut line 510, electrical elements 555b extend a distance (Doverlap,b) beyond cut line 510, electrical elements 550b extend a distance extend a distance (Daway,b) from cut line 510, at elements 550a extend a distance extend a distance (Daway,a) from cut line 510. In one certain case, Doverlap,a is one hundred (100) microns, Doverlap,b is thirty (30) microns, Daway,b is thirty (30) microns, and Daway,a is sixty (60) microns.

As shown in side perspective view 503, each of the electrical elements 550, 555 have a different impact on how laser exposure along cut line 510 effects surface 506. In particular, electrical elements 555a that extend a significant distance beyond cut line 510 result in substantial interference with the laser energy such that large areas (i.e., areas 508, 514) under and in some cases beyond electrical elements 555a are unchanged. In contrast, electrical elements 555b that extend a smaller distance beyond cut line 510 result in less substantial interference with the laser energy such that smaller areas (i.e., areas 516, 518) under and in some cases beyond electrical elements 555b are unchanged. Electrical elements 550b that extend close to cut line 510 result in interference with the laser energy such that areas (i.e., areas 522, 524) beyond electrical elements 550b are unchanged. Electrical elements 550a that do not extend close to cut line 510 do not result in interference with the laser energy such that an area 526 beyond electrical elements 550a is unchanged. Failure to change the characteristic of the material at areas 508, 514, 516, 518, 522, 524 decreases strength in the panel at areas along cut line 510, and can result in a ragged break leaving surface anomalies that are difficult to cover with electrical elements, such as, for example, side electrodes. In some embodiments, the failure to change the characteristic of the material at areas 508, 514, 516, 518, 522, 524 does not result in a ragged edge upon snapping the panel at cut line 510, but can leave areas where the difference in material characteristics make it difficult to cover with electrical elements, such as, for example, side electrodes.

Alternatively, the beam or panel could be placed at an angle relative to one another, such that the angle between the cone of the beam with respect to the center of the tile to be singulated is greater than if the beam were perpendicular to the panel. The position of the focal line could also be raised above the middle of the panel in order to minimize any damage to the electrodes on the laser exit side.

Returning to FIG. 5, once the cut line is finished (block 578), it is determined whether another cut line is to be formed (block 582). Where another cut line is to be formed (block 582), the processes of blocks 572-582 are repeated for the next cut line. Alternatively, where no more cut lines are to be formed (block 582), the panel is snapped along the cut line(s) to yield individual tile(s) (block 584). In some embodiments, the panel is s [symbol] using mechanical pressure acting along the cut line(s). In other embodiments, the panel is snapped using thermal pressure acting along the cut line(s). Turning to FIG. 6i, region 520 is shown after the snapping process has completed leaving tile 509 separated from tiles 507, 511, and an outer edge 560 of tile 509.

Some embodiments provided herein yield display tiles exhibiting a uniform edge that does not have sharp or abrupt features; minimal damage/defects on top, bottom and/or side surfaces; and/or cut lines and/or polish lines that are very near electrical elements such as, for example, conductive traces on one or more surfaces of the display tiles. Such approaches may allow for minimization or elimination of damage to electrical elements on one or more surfaces of the display tiles. Further, such approaches may reduce the occurrence of discontinuities in side electrodes, and/or allow for thin side electrodes that allow for reducing the distance between individual display tiles in a multi-tile display.

In conclusion, various novel systems, devices, methods and arrangements for direct edge finished displays are discussed herein. While detailed descriptions of one or more embodiments have been given above, various alternatives, modifications, and equivalents will be apparent to those skilled in the art without varying from the spirit of the invention. Therefore, the above description should not be taken as limiting the scope of the invention, which is defined by the appended claims.

1.-39. (canceled)

40. A method for display tile formation, the method comprising:
forming a series of perforation craters along a cut line on a surface of a panel, wherein the panel includes an electrical element formed on the surface of the panel, and wherein the cut line is within two hundred, fifty (250) microns of the electrical element;
separating one portion of the panel from another portion of the panel along the cut line to yield a display tile;
providing an edge processing system, wherein the edge processing system includes:
a display tile fixture configured to hold the display tile in place, wherein the electrical element is formed on the display tile within two hundred, fifty (250) microns of an edge of the display tile;
a processing head including;
a grinding wheel, wherein the grinding wheel includes a groove having a first width at an circumferential outer surface of the grinding wheel that is greater than a thickness of the edge of the display tile, and a second width less than the thickness of the edge of the display tile;
a motor coupled to the grinding wheel and configured to turn the grinding wheel; and
a movable arm;
moving the movable arm such that the grinding wheel moves relative to the display tile fixture until the groove of the grinding wheel is over the edge of the display tile; and
moving the movable arm such that the grinding wheel moves toward the edge of the display tile until opposing sides of the edge of the display tile contact the grinding wheel within the groove such that material from the opposing sides of the edge of the display tile is removed, wherein the edge of the display tile is modified without contact between the grinding wheel and the electrical element.

41. An edge processing system, the system comprising:
a display tile fixture configured to hold a display tile in place, wherein an electrical element is formed on the display tile within two hundred, fifty (250) microns of an edge of the display tile;
a processing head including;
a grinding wheel, wherein the grinding wheel includes a groove having a first width at an circumferential outer surface of the grinding wheel that is greater than a thickness of the edge of the display tile, and a second width less than the thickness of the edge of the display tile;
a motor configured to turn the grinding wheel; and
a movable arm configured to:
move the grinding wheel relative to the display tile fixture until the groove of the grinding wheel is over the edge of the display tile; and
move the grinding wheel toward the edge of the display tile until opposing sides of the edge of the display tile contact the grinding wheel within the groove such that material from each of the opposing sides of the edge of the display tile is removed, wherein the edge of the display tile is modified without contact between the grinding wheel and the electrical element.

42. The edge processing system of claim 41, wherein the electrical element is formed on the display tile within one hundred (100) microns of the edge of the display tile.

43. The edge processing system of claim 41, wherein a profile of the groove results in a modification of the edge of the display tile that replaces an abrupt transition at the edge of the display profile with a rounded edge.

44. The edge processing system of claim 43, wherein the rounded edge exhibits a curve distance of less than sixty (60) microns.

45. The edge processing system of claim 41, wherein the grinding wheel is a resin bonded grinding wheel having between twelve (12) volume percent and twenty (20) volume percent diamond abrasives, and wherein the diamond abrasives are between two (2) microns and twenty (35) microns.

46. The edge processing system of claim 41, wherein the grinding wheel is a metal bonded grinding wheel having between twelve (12) volume percent and twenty (20) volume percent diamond abrasives, and wherein the diamond abrasives are between twelve (12) microns and thirty-two (32) microns.

47. The edge processing system of claim 41, wherein a depth of the groove is less than seventy (70) microns.

48. A method for making display tiles, the method comprising:
mounting a display tile on a display tile fixture, wherein the display tile comprises a glass substrate with at least one electrical element formed on the glass substrate within 250 microns of the edge of the display tile, and wherein the display tile is mounted on the display tile fixture such that the edge of glass substrate extends beyond an edge of the display tile fixture;
moving a grinding wheel relative to the display tile such that opposing sides of the edge of the display tile both extend into a groove in the grinding wheel and contact the grinding wheel below the circumferential outer surface of the grinding wheel, wherein the groove exhibits a first width at an circumferential outer surface of the grinding wheel that is greater than a thickness of the edge of the display tile, and the groove exhibits a second width below the circumferential outer surface of the grinding wheel, and wherein the second width is less than the thickness of the edge of the display tile;
moving the grinding wheel relative to the display tile such that opposing sides of the edge of the display tile both extend into the groove and contact the grinding wheel below the circumferential outer surface of the grinding wheel; and
further moving the grinding wheel toward the display tile such that material from each of the opposing sides of the edge of the display tile is removed, wherein the edge of the display tile is modified without contact between the grinding wheel and the electrical element.

49. The method of claim 48, the method further comprising:
separating the display tile from a panel, wherein the glass substrate is a portion of the panel.

50. The method of claim 49, wherein the separating the display tile from the panel comprises:
forming a series of perforation craters along a cut line on a surface of a panel, and wherein the cut line is within two hundred, fifty (250) microns of the electrical element; and
mechanically breaking the panel along the cut line.

51. The method of claim 48, wherein:
the grinding wheel includes a distal end and a proximal end, and wherein the groove is located a distance from the distal end;
the display tile fixture exhibits a height; and
the distance is less than the height.

52. The method of claim 48, wherein the edge of the glass substrate extends beyond an edge of the display tile fixture by a distance greater than a depth of the groove.

53. The method of claim 52, wherein the distance is between ten (10) microns and one thousand (1000) microns.

54. The method of claim 52, wherein the depth of the groove is less than seventy (70) microns.

55. The method of claim 48, wherein the electrical element is formed on the display tile within seventy (70) microns of the edge of the display tile.

56. The method of claim 48, wherein a profile of the groove results in a modification of the edge of the display tile that replaces an abrupt transition at the edge of the display profile with a rounded edge.

57. The method of claim 56, wherein the rounded edge exhibits a curve distance of less than sixty (60) microns.

58. The method of claim 48, wherein the at least one electrical element is a first electrical element formed on a first surface of the display tile, the method further comprising:
forming a wrap-around edge electrode extending from the first electrical element to a second electrical element formed on a second surface of the display tile, wherein the second surface is opposite the first surface.

59. A method for display tile formation, the method comprising:
forming a series of perforation craters along a cut line on a surface of a panel, wherein the panel includes an electrical element formed on the surface of the panel, and wherein the cut line is within two hundred, fifty (250) microns of the electrical element; and
separating one portion of the panel from another portion of the panel along the cut line to yield a display tile.

60. The method of claim 59, wherein the cut line is a distance of less than or equal to sixty (60) microns from the electrical element.

61. The method of claim 59, wherein the cut line extends through the electrical element.

62. The method of claim 59, wherein the electrical element is a conductive trace.

63. The method of claim 59, wherein a maximum size of each of the perforation craters is less than forty (40) microns.

64. The method of claim 59, wherein a distance between two adjacent perforation craters is less than forty (40) microns.

65. The method of claim 59, wherein the perforation craters are each formed by exposing the panel to laser energy.

66. The method of claim 59, wherein separating one portion of the panel from another portion of the panel along the cut line to yield the display tile includes mechanically breaking the panel along the cut line.

67. The method of claim 59, wherein the panel is a glass panel.

68. The method of claim 59, the method further comprising:
mounting the display tile on a display tile fixture, wherein the display tile comprises a glass substrate with at least one electrical element formed on the glass substrate within 250 microns of the edge of the display tile, and wherein the display tile is mounted on the display tile fixture such that the edge of glass substrate extends beyond an edge of the display tile fixture;
moving a grinding wheel relative to the display tile such that opposing sides of the edge of the display tile both extend into a groove in the grinding wheel and contact the grinding wheel below the circumferential outer surface of the grinding wheel, wherein the groove exhibits a first width at an circumferential outer surface of the grinding wheel that is greater than a thickness of the edge of the display tile, and the groove exhibits a second width below the circumferential outer surface of the grinding wheel, and wherein the second width is less than the thickness of the edge of the display tile;
moving the grinding wheel relative to the display tile such that opposing sides of the edge of the display tile both extend into the groove and contact the grinding wheel below the circumferential outer surface of the grinding wheel; and
further moving the grinding wheel toward the display tile such that material from each of the opposing sides of the edge of the display tile is removed, wherein the edge of the display tile is modified without contact between the grinding wheel and the electrical element.
